(19) United States
(12) Patent Application Publication
(10) Pub. No.: US 2026/0135479 A1
(43) Pub. Date: May 14, 2026

(54) AUTOMATICALLY-RECONFIGURABLE CHARGE PUMP SYSTEM

(71) Applicant: COMMISSARIAT À L'ENERGIE ATOMIQUE ET AUX ENERGIES ALTERNATIVES, Paris (FR)

(72) Inventors: Gwenael BECHET, Grenoble (FR); Quentin BERAUD-SUDREAU, Grenoble (FR)

(73) Assignee: COMMISSARIAT À L'ENERGIE ATOMIQUE ET AUX ENERGIES ALTERNATIVES, Paris (FR)

(21) Appl. No.: 19/384,765

(22) Filed: Nov. 10, 2025

(30) Foreign Application Priority Data
Nov. 8, 2024 (FR) 24/12292

(51) Int. Cl. H02M 3/07; H02M 1/00

(52) U.S. Cl. CPC H02M 3/07; H02M 1/0045

(57) ABSTRACT

A charge pump system including: a charge pump including a number of pump stages, each pump stage being configured to be activated or deactivated; a voltage regulator connected to the charge pump; an activation device configured to: obtain a prediction result corresponding to a difference between a prediction voltage representative of a modification in the number of activated pump stages and a regulator output voltage, modify, or not, the number N of activated pump stages according to the obtained prediction result, so as to modify, or not, the pump output voltage so that the difference between the pump output voltage and the regulator output voltage is regulated and included within a predefined operating voltage range.

### TECHNICAL FIELD

The invention relates to energy conversion in integrated electronic circuits. In particular, the invention relates to a charge pump system comprising in particular a charge pump, a voltage regulator and a prediction circuit.

### PRIOR ART

A linear voltage regulator or “Low Dropout Regulator” in the Anglo-Saxon terminology is an electronic device which keeps an output voltage constant despite the variations in the input voltage. Unlike switching regulators, linear voltage regulators are valued for their simple design, their low electrical noise and their fast response to load changes, which makes them suitable for sensitive applications.

A charge pump is an electronic circuit which converts an input voltage into a higher or lower output voltage using switches and capacitors. The charge pump is often used to efficiently generate a required voltage in a system without the need for transformers or inductors.

A charge pump may be used to power a voltage regulator. Thus, the charge pump delivers an adjusted supply voltage to the voltage regulator. The charge pump may increase or reduce the input voltage so that it is closer to the output voltage desired by the voltage regulator. This enables the voltage regulator to operate more efficiently, because the difference between the input voltage and the output voltage is reduced, thereby minimizing power losses and improving the overall efficiency of the system.

A linear voltage regulator receives an input voltage and regulates this input voltage to deliver a stable output voltage. A reference internal or external to the linear voltage regulator, so-called the monitoring voltage, determines the value of the output voltage. The linear voltage regulator compares the monitoring voltage with the output voltage via a feedback network, and adjusts the output voltage so as to minimize the error between the monitoring voltage and the voltage having been subjected to a feedback.

The operating mode of the linear voltage regulator, whether in regulation or in linear operation, depends on the relationship between the supply voltage and the output voltage. When the supply voltage is sufficiently higher than the output voltage, the linear voltage regulator operates efficiently in regulation. If the supply voltage decreases below a given threshold and approaches the output voltage, the linear voltage regulator can enter the linear mode, where the voltage regulation and the noise rejection are degraded, generates more heat and the efficiency of the system is degraded.

The monitoring voltage of the linear regulator is essential for these dynamics. If the monitoring voltage changes, for example, by decreasing because of a change in the temperature in the surrounding environment, the linear voltage regulator should adjust the output voltage accordingly. If the linear voltage regulator is unable to keep the required difference between the supply voltage and the output voltage, the linear voltage regulator might operate in the linear mode, thereby degrading the performances of the system.

It is known from the prior art to keep the linear voltage regulator in its regulation operation area by selecting a static and satisfactory input voltage for the highest value of the output voltage to address. Nevertheless, in this case, the overall efficiency for low output voltages is under-optimized. In addition, this solution is not suitable when the input voltage itself varies over time.

The present invention aims to overcome the drawback set out hereinabove and to enable a regulation operation of the linear voltage regulator that is not affected by the variations in the monitoring voltage or in the input voltage.

### SUMMARY OF THE INVENTION

The present invention relates to a charge pump system comprising:
a charge pump connected between an input terminal and a reference terminal to an input power supply external to the charge pump system to receive an input supply voltage and to generate, according to the input supply voltage, at the output of the charge pump between an output terminal and the reference terminal, a pump output voltage, the charge pump comprising a number Nmax of pump stages, and each pump stage being configured to be activated or deactivated, the number N of activated pump stages being comprised between 0 and Nmax,
a voltage regulator connected to the charge pump between the output terminal and the reference terminal, and configured to receive the pump output voltage at the input of said voltage regulator and to generate, on the basis of the pump output voltage, a regulator output voltage,
an activation device configured to:
obtain a prediction result corresponding to a difference between a prediction voltage representative of a modification in the number of activated pump stages and the regulator output voltage,
modify, or not, the number N of activated pump stages according to the obtained prediction result, so as to modify, or not, the pump output voltage so that the difference between the pump output voltage and the regulator output voltage is regulated and comprised within a predefined operating voltage range.

Advantageously, powering the voltage regulator by means of a charge pump allows improving an efficiency of the charge pump system compared to powering the voltage regulator directly from the power supply source that delivers the input supply voltage.

Thanks to the arrangements according to the invention, a circuit for automatically reconfiguring the charge pump is obtained. The charge pump system allows taking account of the variations in the input voltage or in the reference voltage.

According to one embodiment, the range of operating voltages or predetermined voltage range is comprised between a low threshold and a high threshold.

According to one possibility, the charge pump is of the step-down type, further comprising a prediction circuit configured to generate said prediction voltage at the output of the prediction circuit.

According to one possibility, the prediction circuit is configured to generate said prediction voltage at the output of the prediction circuit out of at least one intermediate voltage present in said charge pump at the output of the stages of said charge pump.

According to one possibility, the prediction circuit is configured to generate said prediction voltage at the output of the prediction circuit out of at least one input voltage or output voltage of said charge pump.

These arrangements are suited to use with a step-down charge pump. Indeed, in this case, the evolution of the voltage in the case of an increase in the number of stages should be predicted, because the voltage corresponding to the number of stages corresponding to an increase is not available at the terminals of one of the activated stages of the charge pump.

According to one possibility, the prediction voltage is representative of a modification in the number of activated pump stages corresponding to a number of stages greater than a current number of activated stages of the charge pump.

According to one possibility, each pump stage is configured to receive at the input an input intermediate voltage and to generate at the output of said pump stage, on the basis of the input intermediate voltage, an output intermediate voltage, the prediction circuit is configured to sample a plurality of input or output intermediate voltages, and the prediction circuit comprises:
a multiplexer configured to select an input intermediate voltage amongst the sampled input intermediate voltages,
at least one modification stage configured to generate a prediction voltage on the basis of the selected intermediate voltage, the at least one modification stage being configured to have a structure identical to a pump stage of the charge pump.

Advantageously, the prediction circuit comprising a multiplexer allows sampling a plurality of output intermediate voltages at different nodes of the charge pump, thereby allowing varying the voltage at the input of the prediction circuit.

According to one possibility, the input intermediate voltage of a pump stage of the rank i+1 corresponds to the output intermediate voltage of a pump stage of the rank i, the rank i being comprised between 1 and Nmax.

According to one embodiment, the selection carried out by the multiplexer is controlled by the activation device and corresponds to the number N of activated stages.

According to one embodiment, at least one modification stage is configured to have a structure similar to a pump stage of the charge pump.

Thus, the modification stage simulates the behavior of a pump stage because it has a similar or identical structure comprising the same components.

According to one embodiment, the modification stage receives the same activation commands as a pump stage of the charge pump it simulates.

According to one possibility, each pump stage is configured to receive at the input an input intermediate voltage and to generate at the output of said pump stage, on the basis of the input intermediate voltage, an output intermediate voltage, the prediction circuit comprising:
a resistive voltage divider bridge connected between a first terminal selected amongst the output terminal and the input terminal and a second terminal corresponding to the reference terminal,
the resistive voltage divider bridge comprising a plurality of resistive components, each resistive component being configured so that the voltage at the terminals of each resistive component corresponds to the input intermediate voltage or the output intermediate voltage of the corresponding pump stage,
a multiplexer connected at the terminals of at least one resistive component amongst the plurality of resistive components and configured to select a voltage amongst the voltages at the terminals of the resistive components, the selected voltage corresponding to the prediction voltage.

Advantageously, the charge pump system comprising the resistive voltage divider bridge reduces the bulk by 20% compared to the charge pump system with capacitive division.

According to one embodiment, the selection carried out by the multiplexer is controlled by the activation device and corresponds to the number N of activated stages.

According to one possibility, each resistive component has, between the terminals of said resistive component, a resistance value defined according to the number of activated pump stage(s).

Advantageously, it is possible to act on the number of activated pump stages to modify the value of the resistance of the resistive component.

According to one possibility, said charge pump is of the step-down type, and the activation device is configured to:
measure a first voltage difference between the current pump output voltage and the regulator output voltage,
if said first difference is lower than a low threshold, modify the number of activated pump stages by reducing said number N of activated pump stages,
if said first difference is higher than a high threshold, obtain said prediction result corresponding to a second difference between the prediction voltage and the regulator output voltage, and if the prediction result is higher than the low threshold, modify the number of activated pump stages by increasing said number of activated pump stages, and
keep the number N of activated pump stages unchanged if the first difference is comprised between the low threshold and the high threshold.

According to one possibility, said charge pump is of the step-up type, and wherein the prediction voltage is a voltage of a lower number of stages representative of a modification in the number of activated pump stages corresponding to a number of stages lower than a current number of activated stages of the charge pump, the prediction result corresponding to a result of a lower number of stages.

These arrangements are suited to the use of a step-up charge pump. In this case, the voltage of a lower number of stages may be obtained at the terminals of a stage of the charge pump.

According to one possibility, the activation device is configured to:
measure a first voltage difference between the current pump output voltage and the regulator output voltage,
if said first difference is lower than a low threshold, modify the number of activated pump stages by increasing said number N of activated pump stages),
if said first difference is higher than a high threshold, obtain a voltage of a lower number of stages, and obtain a prediction result for a lower number of stages corresponding to a second difference between a voltage of a lower number of stages and the regulator output voltage, and, if the prediction result is higher than the low threshold, modify the number of activated pump stages by reducing said number of activated pump stages,
keep the number N of activated pump stages unchanged if said first difference is comprised between the low threshold and the high threshold.

According to one possibility, the activation device comprises a set of comparators comprising:
A first comparator configured to receive at the input the pump output voltage, the regulator output voltage as well as the low threshold and to compare the difference between the pump output voltage and the regulator output voltage with the low threshold,
A second comparator configured to receive at the input the pump output voltage, the regulator output voltage as well as the high threshold and to compare the difference between the pump output voltage and the regulator output voltage with the high threshold, and
A third comparator configured to receive at the input the prediction voltage, the regulator output voltage as well as the low threshold and to compare the difference between the prediction voltage and the regulator output voltage with the low threshold.

According to one possibility, the activation device comprises a state machine which stores in a memory a number N of activated stages and is configured to modify this number.

According to one possibility, each pump stage of the rank i comprises a capacitive component comprising a first electrode connected, on the one hand, to an input of the pump stage and, on the other hand, connected by a first switch to the input of the pump stage of the rank i+1 or the output voltage; and a second electrode connected, on the one hand, by a second switch to the output terminal and, on the other hand, by a third switch Int3-i to the reference terminal.

Advantageously, the use of switches allows modifying the configuration of the charge pump in a simple and programmed manner in order to modify the pump output voltage. According to one possibility, the charge pump is a Dickson charge pump.

Advantageously, the use of a Dickson charge pump allows modifying the pump output voltage relative to the supply voltage at the input of the charge pump system using a reduced number of active components, which allows improving the efficiency and the compactness of the charge pump system.

According to one possibility, the charge pump system further comprises a micro-electromechanical system connected at the output of the voltage regulator between the reference terminal and an output terminal of the regulator.

Advantageously, the charge pump system allows powering the micro-electromechanical system with a stable voltage, enabling the micro-electromechanical system to have a reliable operation while reducing the risks of malfunctions or failures of the micro-electromechanical system due to voltage fluctuations.

According to one possibility, the number n of pump stages is comprised between 3 and 10, for example four pump stages.

According to one possibility, the number of pump stages may be selected according to the value of the desired pump output voltage.

The present invention also relates to a method for configuring a number of activated pump stages for a charge pump system comprising:
a charge pump connected between an input terminal and a reference terminal to an input power supply external to the charge pump system to receive an input supply voltage and to generate, according to the input supply voltage, at the output of the charge pump between an output terminal and the reference terminal, a pump output voltage, the charge pump comprising a number Nmax of pump stages, and each pump stage being configured to be activated or deactivated, the number N of activated pump stages being comprised between 0 and Nmax,
a voltage regulator connected to the charge pump between the output terminal and the reference terminal, and configured to receive the pump output voltage at the input of said voltage regulator and to generate, on the basis of the pump output voltage, a regulator output voltage,
the method comprising the following steps:
measure a first voltage difference between the pump output voltage and the regulator output voltage,
if said first difference is lower than a low threshold, operate a first modification in the number of activated pump stages,
if said first difference is higher than the high threshold, generate or obtain a prediction voltage representative of a modification in the number of activated pump stages, and obtain a prediction result corresponding to a second difference between the prediction voltage and the regulator output voltage, and, if the prediction result is higher than the low threshold, operate a second modification in the number of activated pump stages, the first and second modifications respectively corresponding to an increase or to a reduction, or vice versa,
if said difference is comprised between the low threshold and the high threshold, keep the number N of activated pump stages unchanged.

According to one possibility, the first modification and the second modification respectively correspond to an increase and to a reduction, or vice versa.

According to one possibility, said charge pump is of the step-down type, and:
the first modification is a reduction in the number of activated stages,
the second modification is an increase in the number of activated pump stages,
the prediction voltage is obtained by a prediction circuit.

According to one possibility, the prediction circuit capable of generating a prediction voltage out of at least one intermediate voltage present in said charge pump at the output of the stages of the charge pump.

According to one possibility, said charge pump is of the step-up type, and:
the first modification is an increase in the number of activated stages,
the second modification is a reduction in the number of activated pump stages,
the prediction voltage corresponds to a voltage of a lower number of stages.

### BRIEF DESCRIPTION OF THE FIGURES

The invention will be described with reference to the next figures which are given for indication and which are not plotted to scale. In these figures, the same references refer to the same elements.

FIG. 1 shows a block diagram of a charge pump system according to the invention, in the case of a step-down charge pump.

FIG. 2 shows an example of a charge pump in a first operation phase.

FIG. 3 shows an example of a charge pump in a second operation phase.

FIG. 4 shows a first embodiment of a prediction circuit for a charge pump system according to the invention.

FIG. 5 shows a second embodiment of a prediction circuit for a charge pump system according to the invention.

FIG. 6 is a flowchart which shows the steps of a method for configuring a number of activated pump stages for a step-down charge pump system.

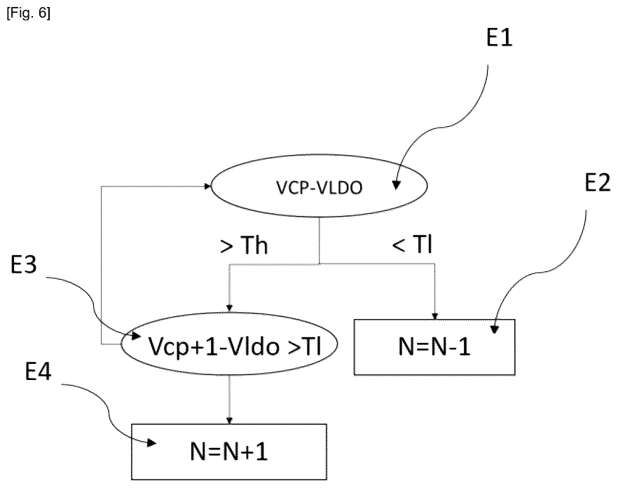

FIG. 7 shows the evolution of the monitoring voltage of the LDO as a function of temperature.

FIG. 8 shows the reference voltage Vref in abscissas and the efficiency in percentage in ordinates for an embodiment of a charge pump system according to the invention and a charge pump carrying out a division by 2.

FIG. 9 shows the evolution of the output voltage Vout and of the reference voltage Vref as a function of time for a charge pump system.

FIG. 10 shows a block diagram of a charge pump system according to the invention in the case of a step-up charge pump.

FIG. 11 is a flowchart which shows the steps of a method for configuring a number of activated pump stages for a step-up charge pump system.

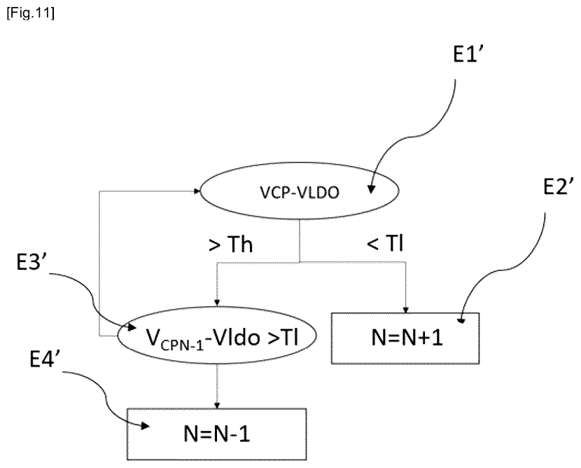

Other advantages and technical features could arise from the following description which is made with reference to the figures described hereinabove.

### DETAILED DESCRIPTION

### Charge Pump System

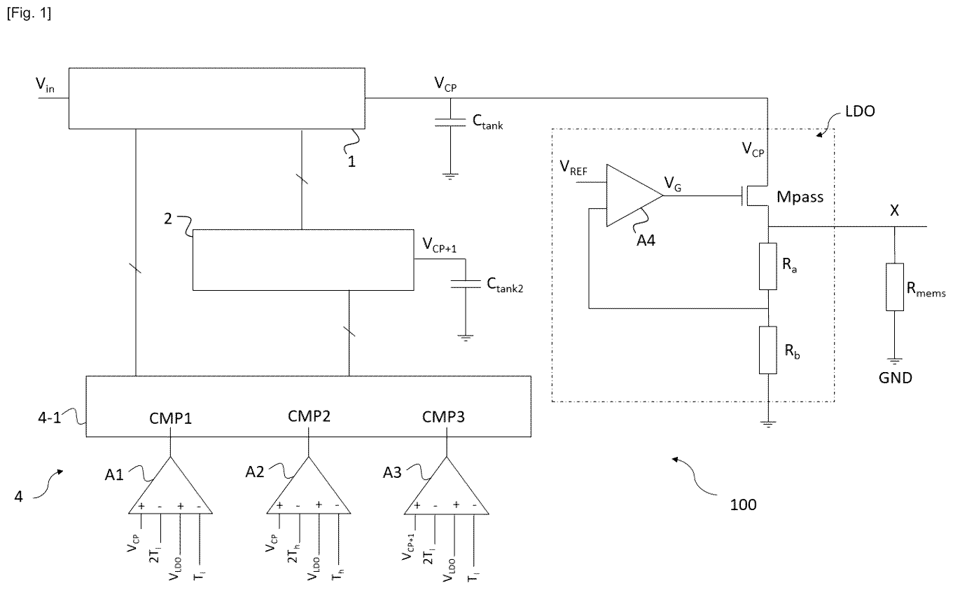

FIG. 1 shows a block diagram of the charge pump system 100.

In particular, FIG. 1 shows the main elements of the charge pump system 100: a charge pump 1, a prediction circuit 2, as well as an activation device 4. A linear voltage regulator LDO is disposed at the output of the charge pump.

The charge pump 1 delivers an output voltage Vcp which is the voltage at the input of the linear voltage regulator LDO.

If the difference between the voltage Vcp at the input of the linear voltage regulator LDO and its output voltage Vldo is comprised within an operating voltage range between a voltage high threshold Th and a voltage low threshold Tl, the linear voltage regulator LDO can operate in a regulation operation area, in other words the linear voltage regulator LDO can have the desired operation. The voltage high threshold and the voltage low threshold may be defined according to characteristics intrinsic to the linear voltage regulator LDO. For example, the low threshold may amount to 150 mV and the high threshold may amount to 200 mV.

The charge pump system 1 allows adapting the output voltage Vcp to remain in the desired operation area of the LDO, or of another load at the output of the charge pump.

The charge pump 1 is a charge pump with several stages that are reconfigurable or of a programmable rank, i.e. the charge pump 1 may have different operation configurations in which the number N of activated pump stages could vary. According to FIG. 1, one could see that the charge pump 1 takes on the supply voltage Vin and reduces the supply voltage Vin through the different pump stages to produce the pump output voltage Vcp whose value corresponds to the voltage at the terminals of a capacitance Ctank connected between the output of the charge pump 1 and a reference terminal GND.

The output voltage of the pump Vcp depends on the number N of activated stages.

Thus, the activation device 4 is configured to adjust the switching sequences of the switches of the charge pump 1 and modify the configuration of the charge pump 1, in particular the number of activated pump stages to keep the desired pump output voltage Vcp.

In particular, the activation device 4 is configured to modify, or not, depending on a prediction result, the number N of activated pump stages Si so as to modify, or not, the pump output voltage Vcp so that the difference between the pump output voltage Vcp and the regulator output voltage Vldo is comprised within the predetermined operating voltage range.

The activation device may use comparisons between the output voltage of the pump Vcp, a prediction voltage Vcp+1, the voltage Vldo, and the high and low reference thresholds Th and Tl.

The prediction circuit 2 aims to generate the prediction voltage Vcp+1, to anticipate the effect of a modification in the number of activated stages, in particular an increase in the number of activated stages relative to the current number of activated stages.

The method implemented by the activation device 4 as well as embodiments of the prediction circuit are detailed later on.

The linear voltage regulator LDO uses the voltage Vcp to produce the regulator output voltage Vldo. The linear voltage regulator LDO guarantees that the regulator output voltage Vldo remains stable despite the variations of the supply voltage Vin.

One objective of the linear voltage regulator LDO is to deliver a stable output voltage Vido out of a pump output voltage Vcp (which is also the voltage at the input of the linear voltage regulator LDO). It is desirable that the difference between the 2 voltages Vcp and Vldo is as low as possible while keeping the LDO in its optimum operation area.

As shown in FIG. 1, the linear voltage regulator LDO comprises a transistor Mpass, monitored by an operational amplifier A4. The linear voltage regulator LDO can adjust the regulator output voltage Vldo by modulating a gate voltage Vg of the transistor Mpass to keep the regulator output voltage Vldo at the desired value.

The operational amplifier A4 may compare a reference voltage Vref with a fraction of the regulator output voltage Vldo obtained by the resistive bridge Ra, Rb. The reference voltage Vref may be generated by a voltage source external to the charge pump system 100, and may vary, in particular because of the temperature variations.

Afterwards, the operational amplifier A4 may adjust the gate voltage Vg to stabilize the output voltage of the regulator Vldo. If the regulator output voltage Vldo decreases, the operational amplifier A4 increases the gate voltage Vg to enable the flow of more current through the transistor Mpass, thereby increasing the regulator output voltage Vldo. If the regulator output voltage Vldo increases, the operational amplifier A4 reduces the gate voltage Vg to reduce the current, thereby increasing the regulator output voltage Vldo. The feedback circuit comprising the resistive bridge Ra, Rb and the operational amplifier A4 aims to keep a regulator output voltage Vldo constant despite the variations in the pump output voltage Vcp.

In FIG. 1, the regulator output voltage Vldo is delivered to a micro-electromechanical system Rmems comprised in the charge pump system 100 and connected at the output of the voltage regulator LDO between the reference terminal GND and an output terminal of the regulator X.

The micro-electromechanical system Rmems may be replaced by any type of electrical loads, and in particular a resistive load.

Advantageously, for a variation in the reference voltage Vref from 100 mV to 500 mV, the use of a prediction circuit 2 for the charge pump system 100 may enable the operation of the linear voltage regulator LDO in the regulation area, and could increase the power efficiency of the charge pump system 100 by about 9%.

The charge pump system 100 may be entirely made in a CMOS technology.

### Activation Device and Method for Configuring the Number of Charge Pump Stages

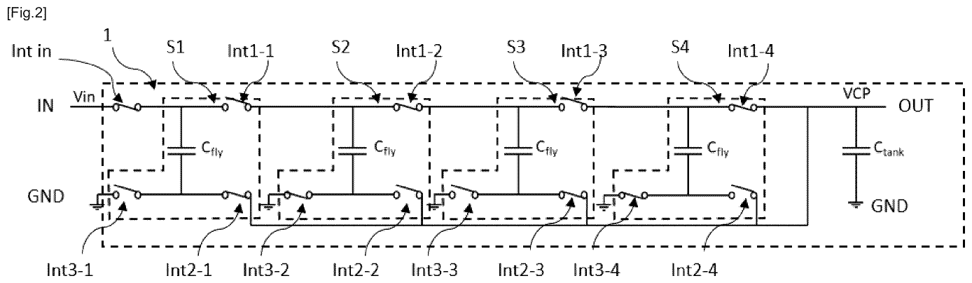

The method for controlling the configuration of a number N of pump stages implemented by the activation device 4 is now described with reference to FIGS. 1 and 2.

The device comprises a state machine 4-1 which stores in a memory a number N of activated stages and is configured to modify this number, as well as a set of comparators A1, A2, A3. For example, the state machine is implemented by a dedicated digital circuit. In particular, the digital circuit may be implemented with integrated logic gates next to the charge pump on the same integrated circuit.

The method for configuring the number of activated pump stages comprises the following steps.

A step of measuring E1 a voltage difference between the pump output voltage Vcp and the regulator output voltage Vldo is carried out. If said difference is lower than the low threshold Tl, for example at 150 mV, the number N of activated pump stages is modified in a step E2 by reducing said number of activated pump stages, for example by one activated pump stage, i.e. N=N−1.

The comparison of the difference between Vcp and Vldo with the low threshold may be carried out by a first comparator A1 which receives at the input Vcp, Vldo as well as the low threshold Tl. As example, a differential difference amplifier or DDA (differential difference amplifier) may be used as a comparator. In this case, the equation giving the output voltage VCMP1, if the four inputs are respectively at the voltages Vcp, 2Tl, Vldo and Tl, is the following one:

$$V CMP 1 = A 1 [ ( V cp - 2 * TI ) - ( V Ido - TI ) ]$$

We deduce:

$$V CMP 1 = A 1 [ ( V cp - V Ido - TI ) ]$$

Namely a measurement of Vcp-Vldo with respect to Tl, with A1 being the gain of the comparator.

If said difference between Vcp and Vldo is higher than the high threshold Th, for example at 200 mV, a prediction result is calculated in a step E3 which corresponds to a difference between the prediction voltage Vcp+1 and the voltage Vldo.

If the difference between Vcp+1 and Vldo is higher than the low threshold Tl, for example at 150 mV, the activation device 4 modifies, in a step E4, the number N of activated pump stages by increasing said number of activated pump stages, for example by one activated pump stage, i.e. N=N+1.

The comparison of the difference between Vcp and Vldo with the high threshold Th may be carried out by a second comparator A2 which receives at the input Vcp, Vldo as well as the high threshold Th. As example, a differential difference amplifier or DDA (differential difference amplifier) may be used as a comparator. In this case, the equation giving the output voltage VCMP2, if the four inputs are respectively at the voltages Vcp, 2Th, Vldo and Th:

$$V CMP 2 = A 2 [ ( V cp - 2 * Th ) - ( V Ido - T h ) ]$$

We deduce:

$$V CMP 2 = A 2 [ ( V cp - V Ido - T h ) ]$$

Namely a measurement of Vcp-Vldo with respect to Th, with A2 being the gain of the comparator.

The comparison of the difference between Vcp+1 and Vldo with the low threshold Tl may be carried out by a third comparator A3 which receives at the input Vcp+1, Vldo as well as the low threshold Tl. As example, a differential difference amplifier or DDA (differential difference amplifier) may be used as a comparator. In this case, the equation giving the output voltage VCMP3, if the four inputs are respectively at the voltages Vcp+1, 2Tl, Vldo and Tl:

$$V CMP 3 = A 3 [ ( V c p + 1 - 2 * TI ) - ( V Ido - TI ) ]$$

We deduce:

$$V CMP 3 = A 3 [ ( V c p + 1 - V Ido - TI ) ]$$

Namely a measurement of Vcp+1−Vldo with respect to Tl, with A3 being the gain of the comparator.

In the case where said difference between Vcp and Vldo is comprised between the low threshold Tl and the high threshold Th, the number N of activated pump stages is kept unchanged. In this case, the charge pump 1 keeps the current pump configuration.

The output voltages of the comparators VCMP1, VCMP2, VCMP3 may be considered as a binary signal, respectively CMP1, CMP2, CMP3, taking on a value 1 if the voltage value is positive, 0 if the value is negative which allows implementing the method disclosed hereinabove in a simple manner.

Thus, if all of the comparison signals CMP1, CMP2 and CMP3 have the value 1, then the number of activated pump stages is increased by one activated stage. If all of the comparison signals CMP1, CMP2 and CMP3 have the value 0, then the number of activated pump stages is reduced by one activated stage. In all other cases, the number N of activated pump stages is kept unchanged.

### Charge Pump

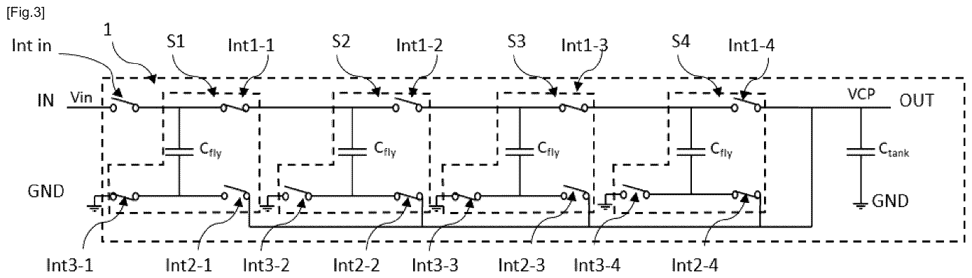

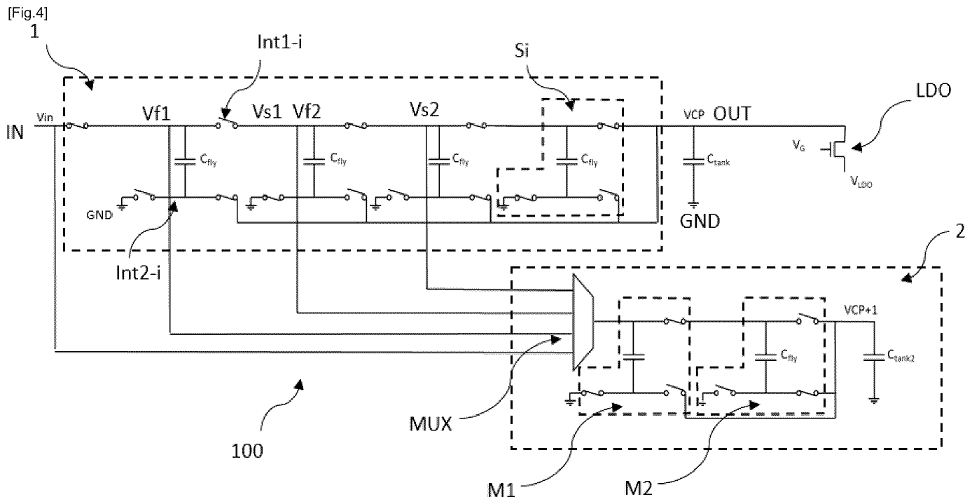

An example of a charge pump 1 will now be described with reference to FIGS. 3 and 4. The charge pump 1 is connected between an input terminal IN and a reference terminal GND to an input power supply external to the charge pump system 100 to receive an input supply voltage Vin. The supply voltage Vin may vary over time in a periodic or non-periodic manner. As example, such a variation may depend on parameters that are not predictable by a component supplying the input voltage, like an ASIC, or be caused by an on-battery operation.

According to the input supply voltage Vin, the charge pump 1 can generate, at the output of the charge pump 1 between an output terminal OUT and the reference terminal GND, a pump output voltage Vcp.

The charge pump 1 may be of the step-down type, i.e. the pump output voltage Vcp is lower than the input supply voltage Vin which is the configuration depicted in FIGS. 1 to 5.

The charge pump 1 may comprise an input switch Int-in and a set comprising n pump stages. In the example of FIGS. 2 and 3, the number n of stages is equal to four, and it is possible to divide the supply voltage Vi by a factor ranging up to five. In other words, the pump output voltage Vcp may be up to five times as low as the supply voltage Vin.

Each pump stage has a rank i, the rank i increasingly evolving starting from the power supply source at the input of the charge pump 1 and in the direction of the pump output.

The pump stages S1, S2, S3, S4 are depicted in FIGS. 2 and 3.

Each pump stage Si comprises a transfer capacitance or capacitor Cfly. A first electrode, which is the top electrode in FIGS. 1 and 2, of the capacitor Cfly is connected, on the one hand, to the input of the stage Si, and, on the other hand, by a first switch Int1-i to the input of the next stage Si+1 (or the output voltage for the last stage).

A second electrode, which is bottom electrode in FIGS. 2 and 3, is connected, on the one hand, by a second switch Int2-i to the output voltage VOUT and, on the other hand, by a third switch Int3-i to a reference terminal GND.

The switches and the transfer capacitors may be made in a CMOS technology. Each switch can switch between a triggered or ON state (in which the switch is closed) and a blocked or OFF state (in which the switch is open). If the switch int1-i of the pump stage Si is in a triggered state, the corresponding pump stage Si is then activated. If the switch int1-i of the pump stage Si is in a blocked state, the corresponding pump stage Si is then deactivated.

The charge pump 1 is reconfigurable or of a programmable rank, i.e. said charge pump 1 may have different operation configurations in which the number N of activated pump stages can vary. In the example of FIG. 3, the charge pump 1 has four pump stages S1, S2, S3, S4 and the number N of activated pump stages can vary between 0 and four depending on triggering and blocking of the switches int10-i. For example, among the pump stages S1 to S4, only the pump stages S1 and S2 can be activated. Each pump stage Si is configured to be activated or deactivated according to an activation signal transmitted to said pump stage Si by the activation device which determines the number N of activated stages. The number N of activated pump stages Si is comprised between 0 and Nmax, the number Nmax of pump stages may be comprised between 3 and 10, for example four pump stages Si.

Each pump stage Si is configured to receive at the input an input intermediate voltage Vfi and to generate at the output of said pump stage, on the basis of the input intermediate voltage Vfi, an output intermediate voltage Vsi, the input intermediate voltage Vfi+1 of a pump stage of the i+1 corresponding to the output intermediate voltage Vsi of a pump stage of the rank i, the rank i being comprised between 1 and Nmax.

The charge pump has two operation phases which alternate periodically, these two phases being respectively depicted in FIGS. 2 and 3.

We describe these two configuration phases at first while assuming that all of the pump stages Si are activated.

In a first phase shown in FIG. 2, the input switch Intin is closed.

The first stage S1 has the first switch Int1-1 open, the second switch Int2-1 closed and the third switch Int3-1 open.

The second stage S2 has the first switch Int1-2 closed, the second switch Int2-2 open and the third switch Int3-2 closed.

The other stages of an odd rank (in FIG. 2, S3) have the same configuration of the switches as S1, the other stages of an even rank (in FIG. 3, S4) have the same configuration of the switches as S2.

In a second phase shown in FIG. 3, the input switch Intin is open.

The first stage S1 has the first switch Int1-1 closed, the second switch Int2-1 open and the third switch Int3-1 closed.

The second stage S2 has the first switch Int1-2 open, the second switch Int2-2 closed and the third switch Int3-2 open.

The other stages of an off rank (in FIG. 3, S3) have the same configuration of the switches as S1, the other stages of an even rank (in FIG. 3, S4) have the same configuration of the switches as S2.

By alternating the first and second phases, charging and discharging of the capacitors, it is possible to obtain a voltage division effect.

Assuming that switchings between the two phases are fast enough and that the voltages in the different capacitors barely evolve,

We approximately obtain:

In the first phase:

$$V cp = V in - V Cfly 1 \qquad ( 1 )$$

$$V cp = V Cfly 4 \qquad ( 2 )$$

In the second phase:

$$V cp = - V Cfly 4 + V Cfly 3 \qquad ( 3 )$$

$$V cp = - V Cly 3 + V Cfly 2 \qquad ( 4 )$$

$$V cp = - V Cfly 2 + V Cfly 1 \qquad ( 5 )$$

By adding (1) to (5), we deduce that Vcp=Vin/5

If one amongst the first switches of a pump stage Si remains closed according to the activation signal delivered by the activation device during the two operation phases, the corresponding stage is deactivated and the division is modified.

Thus:
if the switch Int1-4 remains closed during the two operation phases, a division by 4 is carried out.
if the switches Int1-4 and Int1-3 remain closed during the two operation phases, a division by 3 is carried out.
if the switches Int1-4, Int1-3 and Int1-2 remain closed during the two operation phases, a division by 2 is carried out.
if the switches Int1-4, Int1-3, Int1-2 and Int-1 remain closed during the two operation phases, no division is carried out.

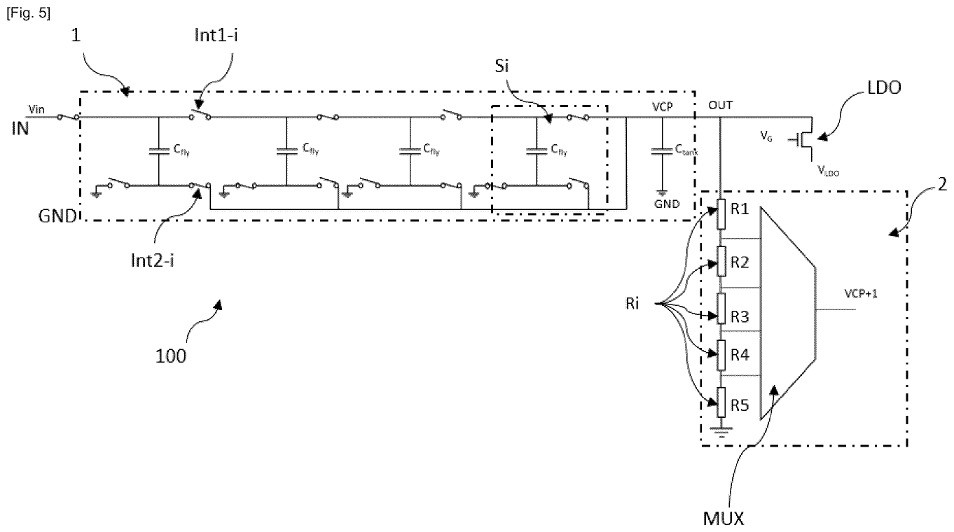

The described charge pump 1 is intended to be used in a charge pump system 100 in combination with a prediction circuit 2 two embodiments of which are depicted in FIGS. 4 and 5.

### Prediction Circuit

### First Embodiment

FIG. 4 shows a first embodiment of a prediction circuit.

FIG. 4 shows a portion of the charge pump system 100 comprising the charge pump 1 as described before and a prediction circuit 2 connected to the charge pump 1. The operation of the charge pump 1 of FIG. 5 is identical to that of FIGS. 3 and 4. A linear voltage regulator or voltage regulator LDO is also connected at the output of the charge pump 1. The voltage regulator LDO is connected to the charge pump 1 between the output terminal OUT and the reference terminal GND, and configured to receive the pump output voltage Vcp at the input of said voltage regulator LDO and to generate, on the basis of the pump output voltage Vcp, a regulator output voltage Vldo.

The prediction circuit 2 is configured to generate a prediction voltage Vcp+1 at the output of the prediction circuit 2 representative of a modification in the number of activated pump stages Si.

The prediction circuit 2 can sample a plurality of input intermediate voltages Vfi, in particular at different nodes of the charge pump 1, and is configured to generate a prediction voltage Vcp+1 on the basis of the selected intermediate voltage Vfi

The prediction circuit 2 of FIG. 4 comprises a multiplexer MUX configured to select an input intermediate voltage Vfi amongst the sampled intermediate voltage Vfi. Thus, the multiplexer is connected at the inputs of each of the pump stages. The selection carried out by the multiplexer is controlled by the activation device 4 and corresponds to the number N of activated stages.

The prediction circuit 2 is configured to operate by capacitive division and comprises at the output of the multiplexer at least one modification stage Mi with a structure similar to a pump stage Si of the charge pump 1. In the case of FIG. 4, the prediction circuit 2 comprises two modification stages M1, M2.

Thus, assuming that N stages are activated, the prediction circuit is configured to sample a voltage VfN at the input of the stage N, the multiplexer being configured to select this voltage amongst its different inputs, and to apply it at the input of the first modification stage which simulates the stage N, the first modification stage is connected to the second modification stage which simulates the stage N+1, the output of this stage corresponding to the voltage Vcp+1 which is established at the terminal of a capacitance Ctank2, connected by an electrode to a reference terminal GND.

The voltage Vcp+1 allows predicting the voltage that would be applied if an additional stage were activated.

In FIG. 4, the charge pump 1 is in an operation phase corresponding to FIG. 2, the stages 1 and 2 being activated. Thus, the modification stages M1 and M2 simulate the stages S2 and S3 to produce a prediction voltage Vcp+1 which would correspond to the activation of the stage 3. The multiplexer is configured to sample the voltage Vf2 at the input of the stage S2.

The activation commands of the modification stage(s) received from the activation device are the same as those of the stage(s) of the charge pump they simulate.

Advantageously, the first embodiment of the charge pump system 100 allows sampling an intermediate voltage Vfi at any pump stage Si.

Thus, the prediction circuit 2 allows generating a prediction voltage Vcp+1 which allows accurately determining the number of pump stages Si that should be activated in order to keep the linear voltage regulator LDO in the regulation operation area.

### Second Embodiment

FIG. 5 depicts a second embodiment of the prediction circuit 2.

The operation of the charge pump 1 shown in FIG. 5 is identical to that of FIGS. 2 and 3. The pump output voltage Vcp is injected at the input of the linear voltage regulator LDO which generates a regulator output voltage Vldo.

The prediction circuit 2 shown in FIG. 5 is different from the prediction circuit 2 of FIG. 4.

The prediction circuit 2 of FIG. 5 is configured to operate by resistive interpolation, i.e. the prediction circuit 2 comprises a resistive voltage divider bridge R1, R2, R3, R4, R5 connected between a first terminal selected amongst the output terminal OUT and the input terminal IN and a second terminal corresponding to the reference terminal GND.

The resistive voltage divider bridge R1, R2, R3, R4, R5 comprises a plurality of resistive components Ri, each resistive component Ri being configured so that the voltage at the terminals of each resistive component Ri corresponds to the input intermediate voltage Vfi of the corresponding pump stage Si. For example, the voltage at the terminals of the resistance R1 may correspond to the input intermediate voltage of the fourth pump stage S1.

One example of calculation of the value of one of the resistances (R1) of the resistive voltage divider bridge is given hereafter.

The equation of the pump output voltage Vcp is the following one:

$${V}_{cp} = \frac{{V}_{in}}{N} - {I}_{load} * \frac{1}{2 * N * {C}_{f} * {f}_{CP}} \qquad [ Math . 1 ]$$

Vin is the supply voltage at the input, N the number of activated pump stages, Iload the load current, Cf the capacitance of each transfer capacitor Cfly and fcp the switching frequency of the charge pump 1.

The equation expresses the pump output voltage Vcp while taking account of the voltage drop due to the load current and to the characteristics of the charge pump 1.

The impedance of the charge pump Z_{0cp} can be calculated according to the following equation:

$${Z}_{0 cp} = \frac{1}{2 * N * {C}_{f} * {f}_{CP}} \qquad [ Math . 2 ]$$

The impedance Z_{0cp} is determined by the characteristics of the charge pump 1, in particular the number N of pump stages, the capacitance of the transfer capacitors Cfly, and the switching frequency fcp.

The prediction voltage Vcp+1 can be calculated according to the following equation:

$${V}_{cp + 1} = \frac{{V}_{in}}{N + 1} - {I}_{load} * \frac{1}{2 * N + 1 * {C}_{f} * {f}_{CP}} \qquad [ Math . 3 ]$$

The prediction voltage Vcp+1 corresponds to a division of the voltage Vcp by the resistive divider bridge R1, R′, with R′ corresponding to the sum of the resistances at the bottom of the divider bridge (R′=R2+R3+R4+R5) and is therefore calculated according to the next equation:

$${V}_{cp + 1} = {V}_{CP} * \frac{{R}^{′}}{R 1 + {R}^{′}} \qquad [ Math . 4 ]$$

By substituting the previous equations to find R1 as a function of R′, the next equation could be obtained:

$$\frac{{V}_{in}}{N + 1} - {I}_{load} * \frac{1}{2 * ( N + 1 ) * {C}_{f} * {f}_{CP}} = ( \frac{{V}_{in}}{N} - {I}_{load} * \frac{1}{2 * N * {C}_{f} * {f}_{CP}} ) * \frac{{R}^{′}}{R 1 + {R}^{′}} \qquad [ Math . 5 ]$$

By developing and simplifying, the next equation can be obtained:

$$( \frac{{V}_{in}}{N + 1} - {I}_{load} * \frac{1}{2 * ( N + 1 ) * {C}_{f} * {f}_{CP}} ) * ( R 1 + {R}^{′} ) = ( \frac{{V}_{in}}{N} - {I}_{load} * \frac{1}{2 * N * {C}_{f} * {f}_{CP}} ) * {R}^{′} \qquad [ Math . 6 ]$$

By isolating the resistance R1, we obtain:

$$R 1 \frac{{V}_{in}}{N + 1} - \frac{{I}_{load} \cdot R 1}{2 * ( N + 1 ) * {C}_{f} * {f}_{CP}} = {R}^{′} ( \frac{{V}_{in}}{N} - \frac{{I}_{load}}{2 * N * {C}_{f} * {f}_{CP}} - \frac{{V}_{in}}{N + 1} + \frac{{I}_{load}}{2 * ( N + 1 ) * {C}_{f} * {f}_{CP}} ) \qquad [ Math . 7 ]$$

By simplifying the previous equation, we obtain:

$$R 1 = {R}^{′} ( \frac{{V}_{in}}{N} - \frac{{I}_{load}}{2 * N * {C}_{f} * {f}_{CP}} - \frac{{V}_{in}}{N + 1} + \frac{{I}_{load}}{2 * ( N + 1 ) * {C}_{f} * {f}_{CP}} ) / \\ ( \frac{{V}_{in}}{N + 1} - {I}_{load} * \frac{1}{2 * ( N + 1 ) * {C}_{f} * {f}_{CP}} ) \qquad [ Math . 8 ]$$

By neglecting the ohmic losses, we obtain:

$$R 1 = {R}^{′} / N \qquad [ Math . 9 ]$$

The prediction circuit 2 also comprises a multiplexer MUX connected at the terminals of at least one resistive component amongst the plurality of resistive components Ri and configured to select a voltage amongst the voltages at the terminals of the resistive components. The selected voltage corresponds to the prediction voltage Vcp+1. The selection carried out by the multiplexer is controlled by the activation device 4 and corresponds to the number N of activated stages.

At the pump output, the voltage divider bridge, which forms a resistor ladder, is connected to divide the pump output voltage Vcp into several voltage levels lower than the pump output voltage Vcp. Afterwards, the multiplexer MUX is used to select the closest voltage of each division rank over this resistor ladder. This allows delivering different accurate voltages at the output of the prediction circuit 2 according to the selected voltage.

Advantageously, the charge pump system 100 with resistive interpolation reduces the bulk compared to the charge pump system 100 with capacitive division. As example, for a pump with 4 stages, therefore a division ratio of 5, the bulk is reduced by 20%.

In FIGS. 1 to 4, the charge pump 1 is a Dickson charge pump. Nevertheless, the charge pump 1 may be of another type, for example a charge pump with diode or a switched-capacitor charge pump.

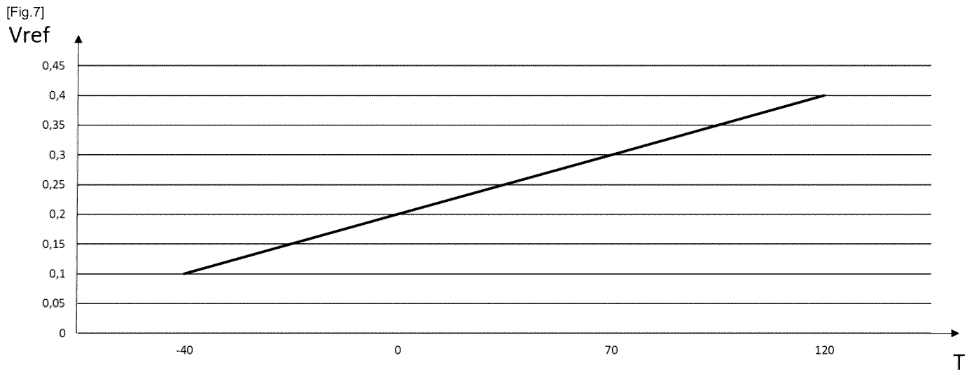

FIG. 7 shows the evolution of the monitoring voltage Vref of the LDO as a function of temperature.

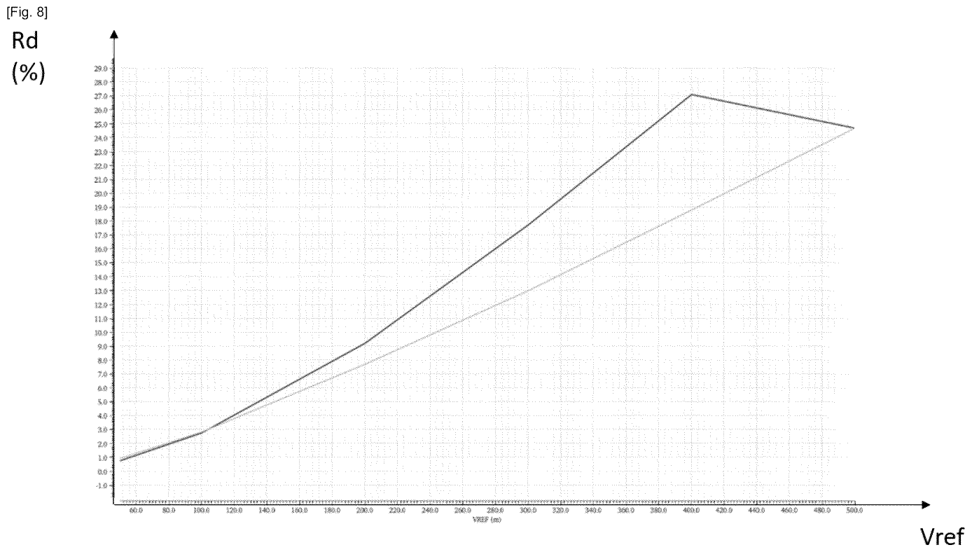

FIG. 8 shows the efficiency of the solution compared to a charge pump with a division by 2, with the reference voltage Vref in abscissas and the efficiency in percentage in ordinates.

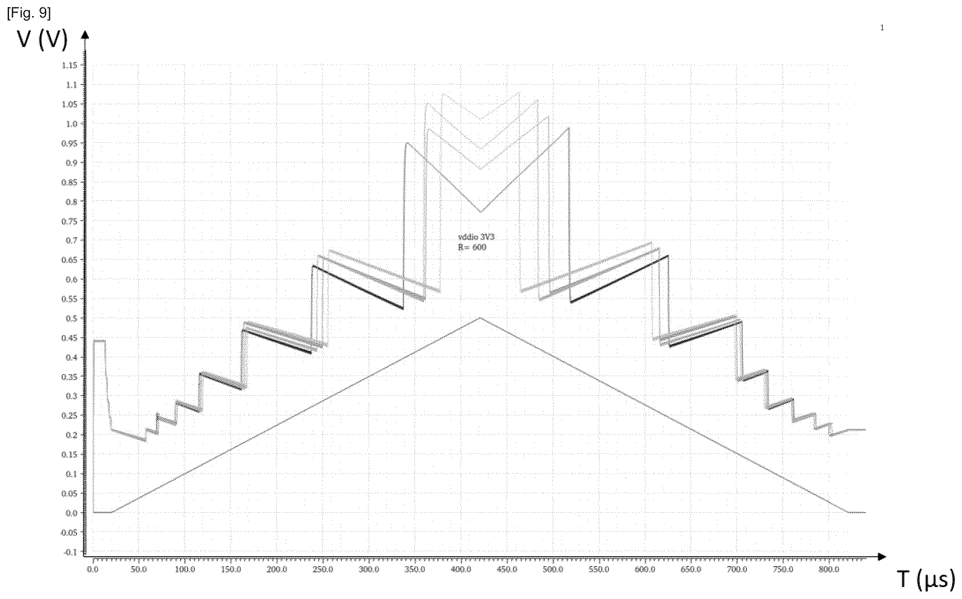

FIG. 9 shows the evolution of the output voltage Vout of a charge pump system and of the reference voltage Vref as a function of time. In the figure, it appears that Vout is always at least 150 mV above Vref. The steps correspond to a change in the division rank, i.e. to a change in the number of activated stages.

Alternatively, according to an embodiment that is not shown, the charge pump 1 may be of the multiplier type, i.e. the pump output voltage Vcp is higher than the input supply voltage Vin.

### Application to a Voltage Step-Up Charge Pump

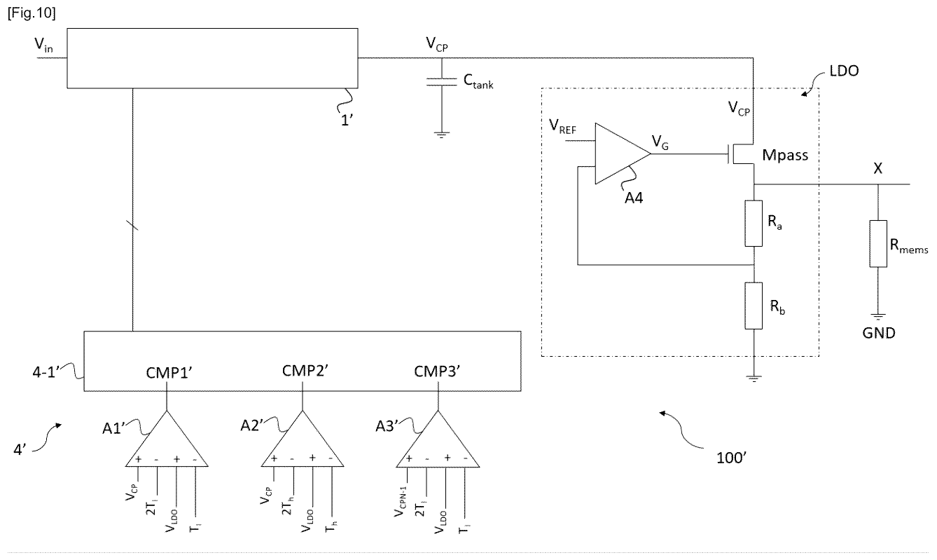

FIG. 10 shows a block diagram of the charge pump system 100′ in the case of a step-up charge pump.

In particular, FIG. 10 shows the main elements of the charge pump system 100′: a step-up charge pump 1′, as well as an activation device 4′. A linear voltage regulator LDO is disposed at the output of the charge pump.

The charge pump 1′ is reconfigurable or of a programmable rank, i.e. said charge pump 1′ may have different operation configurations in which the number N of activated pump stages can vary, the output voltage of the pump being even higher as the number of activated stages is high.

Each pump stage is configured to be activated or deactivated according to an activation signal transmitted to said pump stage by the activation device which determines the number N of activated stages. The number N of activated pump stages is comprised between 0 and Nmax, the number Nmax of pump stages may be comprised between 3 and 10, for example four pump stages.

The activation device 4′ comprises a state machine 4-1′ which stores in a memory a number N of activated stages and is configured to modify this number, as well as a set of comparators A1′, A2′, A3′. For example, the state machine is implemented by a dedicated digital circuit. In particular, the digital circuit may be implemented with integrated logic gates next to the charge pump on the same integrated circuit.

The method for configuring the number of activated pump stages comprises the following steps.

A step of measuring E1′ a voltage difference between the pump output voltage Vcp and the regulator output voltage Vldo is carried out. If said difference is lower than the low threshold Tl, for example at 150 mV, the number N of activated pump stages is modified in a step E2′ by increasing said number of activated pump stages, for example by one activated pump stage, i.e. N=N+1.

The comparison of the difference between Vcp and Vldo with the low threshold may be carried out by a first comparator A1′ which receives at the input Vcp, Vldo as well as the low threshold Tl. As example, a differential difference amplifier or DDA (differential difference amplifier) may be used as a comparator. In this case, the equation giving the output voltage VCMP1′, if the four inputs are respectively at the voltages Vcp, 2Tl, Vldo and Tl, is the following one:

$$VCMP {1}^{′} = A {1}^{′} [ ( Vcp - {2}^{*} Tl ) - ( Vldo - Tl ) ]$$

We deduce:

$$VCMP {1}^{′} = A {1}^{′} [ ( Vcp - Vldo - Tl ) ]$$

Namely a measurement of Vcp-Vldo with respect to Tl, with A1′ being the gain of the comparator.

If said difference between Vcp and Vldo is higher than the high threshold Th, for example at 200 mV, a result of a lower number of stages (or prediction result) is calculated in a step E3′ which corresponds to a difference between an output voltage of the stage N−1 of the charge pump V_{CPN-1} (or voltage of a lower number of stages which corresponds to the prediction voltage) and the regulator output voltage Vldo.

If the difference between V_{CPN-1} and Vldo is higher than the low threshold Tl, for example at 150 mV, the activation device 4 modifies, in a step E4′, the number N of activated pump stages by reducing said number of activated pump stages, for example by one activated pump stage, i.e. N=N−1.

The comparison of the difference between Vcp and Vldo with the high threshold Th may be carried out by a second comparator A2 which receives at the input Vcp, Vldo as well as the high threshold Th. As example, a differential difference amplifier or DDA (differential difference amplifier) may be used as a comparator. In this case, the equation giving the output voltage VCMP2, if the four inputs are respectively at the voltages Vcp, 2Th, Vldo and Th:

$$VCMP {2}^{′} = A {2}^{′} [ ( Vcp - {2}^{*} Th ) - ( Vldo - Th ) ]$$

We deduce:

$$VCMP {2}^{′} = A {2}^{′} [ ( Vcp - Vldo - Th ) ]$$

Namely a measurement of Vcp-Vldo with respect to Th, with A2′ being the gain of the comparator.

The comparison of the difference between V_{CPN-1} and Vldo with the low threshold Tl may be carried out by a third comparator A3′ which receives at the input V_{CPN-1}, Vldo as well as the low threshold Tl. As example, a differential difference amplifier or DDA (differential difference amplifier) may be used as a comparator. In this case, the equation giving the output voltage VCMP3′, if the four inputs are respectively at the voltages V_{cpN-1}, 2Tl, Vldo and Tl:

$$VCMP {3}^{′} = A {3}^{′} [ ( {V}_{CPN - 1} - {2}^{*} Tl ) - ( Vldo - Tl ) ]$$

We deduce:

$$VCMP {3}^{′} = A {3}^{′} [ ( {V}_{CPN - 1} - Vldo - Tl ) ]$$

Namely a measurement of VcpN1−Vldo with respect to Tl, with A3′ being the gain of the comparator.

In the case where said difference between Vcp and Vldo is comprised between the low threshold Tl and the high threshold Th, the number N of activated pump stages is kept unchanged. In this case, the charge pump 1′ keeps the current pump configuration.

The output voltages of the comparators VCMP1′, VCMP2′, VCMP3′ may be considered as a binary signal, respectively CMP1′, CMP2′, CMP3′, taking on a value 1 if the voltage value is positive, 0 if the value is negative which allows implementing the method disclosed hereinabove in a simple manner.

Thus, if all of the comparison signals CMP1′, CMP2′ and CMP3′ have the value 1, then the number of activated pump stages is reduced by one activated stage. If all of the comparison signals CMP1′, CMP2′ and CMP3′ have the value 0, then the number of activated pump stages is increased by one activated stage. In all other cases, the number N of activated pump stages is kept unchanged.

1. A charge pump system comprising:
a charge pump connected between an input terminal and a reference terminal to an input power supply external to the charge pump system to receive an input supply voltage and to generate, according to the input supply voltage, at the output of the charge pump between an output terminal and the reference terminal, a pump output voltage, the charge pump comprising a number Nmax of pump stages, and each pump stage being configured to be activated or deactivated, the number N of activated pump stages being comprised between 0 and Nmax,
a voltage regulator connected to the charge pump between the output terminal and the reference terminal, and configured to receive the pump output voltage (Vep) at the input of the voltage regulator and to generate, on the basis of the pump output voltage, a regulator output voltage,
an activation device configured to:
obtain a prediction result corresponding to a difference between a prediction voltage representative of a modification in the number of activated pump stages and the regulator output,
modify, or not, the number N of activated pump stages according to the obtained prediction result, so as to modify, or not, the pump output voltage so that the difference between the pump output voltage (Vop) and the regulator output voltage is regulated and comprised within a predefined operating voltage range.

2. The charge pump system according to claim 1, wherein the charge pump is of the step-down type, further comprising a prediction circuit configured to generate the prediction voltage at the output of the prediction circuit.

3. The charge pump system according to claim 2, wherein the prediction voltage is representative of a modification in the number of activated pump stages corresponding to a number of stages greater than a current number of activated stages of the charge pump.

4. The charge pump system according to claim 2, wherein each pump stage is configured to receive at the input an input intermediate voltage and to generate at the output of the pump stage, on the basis of the input intermediate voltage, an output intermediate voltage,
the prediction circuit is configured to sample a plurality of input or output intermediate voltages, and the prediction circuit comprises:
a multiplexer configured to select an input intermediate voltage amongst the sampled input intermediate voltages (Vfi),
at least one modification stage configured to generate a prediction voltage on the basis of the selected intermediate voltage, the at least one modification stage being configured to have a structure identical to a pump stage of the charge pump.

5. The charge pump system according to claim 2, wherein each pump stage is configured to receive at the input an input intermediate voltage and to generate at the output of the pump stage, on the basis of the input intermediate voltage, an output intermediate voltage, the prediction circuit comprising:
a resistive voltage divider bridge connected between a first terminal selected amongst the output terminal and the input terminal and a second terminal corresponding to the reference terminal,
the resistive voltage divider bridge comprising a plurality of resistive components, each resistive component being configured so that the voltage at the terminals of each resistive component corresponds to the input intermediate voltage or the output intermediate voltage of the corresponding pump stage,
a multiplexer connected at the terminals of at least one resistive component amongst the plurality of resistive components and configured to select a voltage amongst the voltages at the terminals of the resistive components, the selected voltage corresponding to the prediction voltage.

6. The charge pump system according to claim 5, wherein each resistive component has, between the terminals of said resistive component component, a resistance value defined according to the number of activated pump stage(s).

7. The charge pump system according to claim 2, wherein the charge pump is of the step-down type, and wherein the activation device is configured to:
measure a first voltage difference between the current pump output voltage and the regulator output voltage,
if the first difference is lower than a low threshold, modify the number of activated pump stages by reducing the number of activated pump stages,
if the first difference is higher than a high threshold, obtain the prediction result corresponding to a second difference between the prediction voltage and the regulator output voltage, and if the prediction result is higher than the low threshold, modify the number of activated pump stages by increasing the number of activated pump stages, and
keep the number N of activated pump stages unchanged if the first difference is comprised between the low threshold and the high threshold.

8. The charge pump system according to claim 1, wherein the charge pump is of the step-up type, and wherein the prediction voltage is a voltage of a lower number of stages representative of a modification in the number of activated pump stages corresponding to a number of stages lower than a current number of activated stages of the charge pump, the prediction result corresponding to a result of a lower number of stages.

9. The charge pump system according to claim 8, wherein the activation device is configured to:
measure a first voltage difference between the current pump output voltage and the regulator output voltage,
if the first difference is lower than a low threshold, modify the number of activated pump stages by increasing the number N of activated pump stages,
if the first difference is higher than a high threshold, obtain a voltage of a lower number of stages, and obtain a prediction result for a lower number of stages corresponding to a second difference between a voltage of a lower number of stages and the regulator output voltage, and, if the prediction result is higher than the low threshold, modify the number of activated pump stages by reducing the number of activated pump stages,
keep the number N of activated pump stages unchanged if the first difference is comprised between the low threshold and the high threshold.

10. The charge pump system according to claim 1, wherein the activation device comprises a set of comparators comprising:
a first comparator configured to receive at the input the pump output voltage, the regulator output voltage as well as the low threshold and to compare the difference between the pump output voltage and the regulator output voltage with the low threshold,
a second comparator configured to receive at the input the pump output voltage, voltage, the regulator output voltage as well as the high threshold and to compare the difference between the pump output voltage and the regulator output voltage with the high threshold, and
a third comparator configured to receive at the input the prediction voltage, the regulator output voltage as well as the low threshold and to compare the difference between the prediction voltage and the regulator output voltage with the low threshold.

11. The charge pump system according to claim 1, wherein each pump stage of the rank i comprises a capacitive component comprising a first electrode connected, on the one hand, to an input of the pump stage and, on the other hand, connected by a first switch to the input of the pump stage of the rank i+1 or the output voltage; and a second electrode connected, on the one hand, by a second switch to the output terminal and, on the other hand, by a third switch Int3-i to the reference terminal.

12. The charge pump system according to claim 1, further comprising a micro-electromechanical system connected at the output of the voltage regulator between the reference terminal and an output terminal of the regulator.

13. A method for configuring a number of activated pump stages for a charge pump system comprising:
a charge pump connected between an input terminal and a reference terminal to an input power supply external to the charge pump system to receive an input supply voltage and to generate, according to the input supply voltage, at the output of the charge pump between an output terminal and the reference terminal, a pump output voltage, the charge pump comprising a number Nmax of pump stages, and each pump stage being configured to be activated or deactivated, the number N of activated pump stages being comprised between 0 and Nmax,
a voltage regulator connected to the charge pump between the output terminal and the reference terminal, terminal, and configured to receive the pump output voltage at the input of said voltage regulator and to generate, on the basis of the pump output voltage, a regulator output voltage,
the method comprising the following steps:
measure a first voltage difference between the pump output voltage and the regulator output,
if the first difference is lower than a low threshold, operate a first modification in the number of activated pump stages,
if the first difference is higher than the high threshold, generate or obtain a prediction voltage representative of a modification in the number of activated pump stages, and obtain a prediction result corresponding to a second difference between the prediction voltage and the regulator output voltage, and, if the prediction result is higher than the low threshold, operate a second modification in the number of activated pump stages, the first and second modifications respectively corresponding to an increase or to a reduction, or vice versa,
if the difference is comprised between the low threshold and the high threshold, keep the number N of activated pump stages unchanged.

14. The method according to claim 13, wherein
the charge pump is of the step-down type, and wherein:
the first modification is a reduction in the number of activated stages,
the second modification is an increase in the number of activated pump stages,
the prediction voltage is obtained by a prediction circuit.

15. The method according to claim 13, wherein the charge pump is of the step-up type, and wherein:
the first modification is an increase in the number of activated stages,
the second modification is a reduction in the number of activated pump stages,
the prediction voltage corresponds to a voltage of a lower number of stages.
